(19) United States
(12) Patent Application Publication
(10) Pub. No.: US 2003/0041152 A1
(43) Pub. Date: Feb. 27, 2003

(54) Distributed communication system

(76) Inventors: David Schmeltzle, Hackettstown, NJ (US); William Spain, Easton, PA (US); Robert Van Gent, Branchville, NJ (US); William Weber, Crandord, NJ (US); Richard DeSimone, Far Hills, NJ (US)

Correspondence Address: KAPLAN & GILMAN , L.L.P., 900NROUTE 9 NORTH, WOODBRIDGE, NJ, 07095, US

(21) Appl. No.: 09/933,891

(22) Filed: Aug. 21, 2001

(51) Int. Cl. G06F 15/16

(52) U.S. Cl. 709/229; 709/218

(57) ABSTRACT

The present invention provides a system and method for establishing and controlling communication services within a multiple occupant facility without requiring individual occupant users to have a PBX. The system involves transmitting external communications from a communication service provider to a computer within the multiple occupant facility and connecting the computer to each individual user's communication device as segregated by occupant group. The computer is programmed to be able to establish, modify, and deactivate service to each communication device as required.

### FIELD OF THE INVENTION

The present invention relates to the field of communications, and more particularly, to communication equipment and services in a multiple occupant facility such as an office building housing plural businesses.

### BACKGROUND OF THE INVENTION

It is common for a plurality of businesses to be housed in one office building with each such business occupying a portion of the building. In some such cases, a business may occupy a portion of a floor, an entire floor, or a portion of several floors, depending on the structure of the building and the needs of the business. In similar fashion, an apartment house is home to multiple families in individual apartments. Also, a corporate park may include multiple businesses in several buildings. Each such grouping for housing plural entities in a common enclosure is referred to hereafter as a multiple occupant facility and would benefit from the present invention.

The individual entities within the multiple occupant facility typically require a variety of communication services, for example telephone, computer, internet access, television, and the like. The existing arrangements require a customer to individually contract with each communication service provider (CSP) for the service required. Each business customer having multiple communication lines requires a separate private branch exchange (PBX) which connects calls to and from the individual telephones. The PBX may also add other services, such as conferencing, call forwarding, etc.

The CSP connects a transmission device, for example an external cable or satellite signal-receiving disc to the customer's PBX, which is connected to the individual telephone extensions in order to connect and disconnect internal and external calls. Service may differ for each extension in the customer's system.

When a customer business moves or adds telephone extensions or lines or requires other changes in service, the business must communicate its request to the CSP, which may be unable to respond quickly because of its backlog or its size. Often, the arrangement requires a technician from the PBX provider to visit the customer site to provide changes in service at a substantial fee to the end customer.

The drawbacks and cost inefficiency of the present system involve the size of the average CSP and the resultant inability to respond quickly and efficiently to service change requests of individual businesses and families. Also, the present invention recognizes that improved efficiency will be attained, by combining the provision of space rental service with communication service. Further, the individual business user is required to obtain and maintain a PBX.

Other disadvantages include the requirement to upgrade the PBX equipment as new technology is developed. This results in increased cost. Moreover, there is inefficiency because each office suite would normally have a large amount of unused capacity in its telephone system. This unused capacity of all office suites' equipment in a particular building represents a costly inefficiency.

Therefore, it is an object of the present invention to provide a system for communication services to individual entities such as businesses housed in a multiple occupant facility that is efficient to implement changing requirements of individual users.

It is a further object of the present invention to provide a system for communication services to individual users by multiple occupant facility management.

It is an object of the invention to provide a software system and method for billing users of a telecomunnications system in a manner that prorates the cost based upon ascertainable parameters, and which eliminates the inefficiencies of the prior art discussed above.

These and other objects will become more apparent from the description of the invention to follow.

### SUMMARY OF THE INVENTION

The present invention provides a system in which distributed communications for individual business entities housed in a multiple occupant facility can be quickly and efficiently set up or modified. One or more CSP's connect external communications capabilities to a central communication computer in the multiple occupant facility. Individual cables, typically pre-wired in the building, connect from the central computer to each customer, or communication device, without requiring the business customer to own a PBX. The central computer is controlled by a system administrator who can enable or disable basic service and each service feature for the individual customer. The central computer additionally functions to connect, monitor, and disconnect calls. The individual business customer thus deals with a system administrator within the multiple occupant facility rather than the CSP.

In another embodiment, software is provided that accepts as input a parameter of a tenant company's lease. For example, the square footage leased may be used. The billing software then allocates a periodic fee per unit of parameter, and bills each tenant as appropriate.

### BRIEF DESCRIPTION OF THE DRAWINGS

FIG. 1 is diagrammatic representation of a telephone system of the prior art in which a CSP is connected by multiple cables to a number of customers;

FIG. 2 is a diagrammatic representation of a telephone system according to the invention in which a CSP is connected by a single cable to a multiple occupant facility server, and the server is connected to the individual communication devices; and

FIG. 3 is a more detailed embodiment of the present invention.

### DETAILED DESCRIPTION OF THE INVENTION

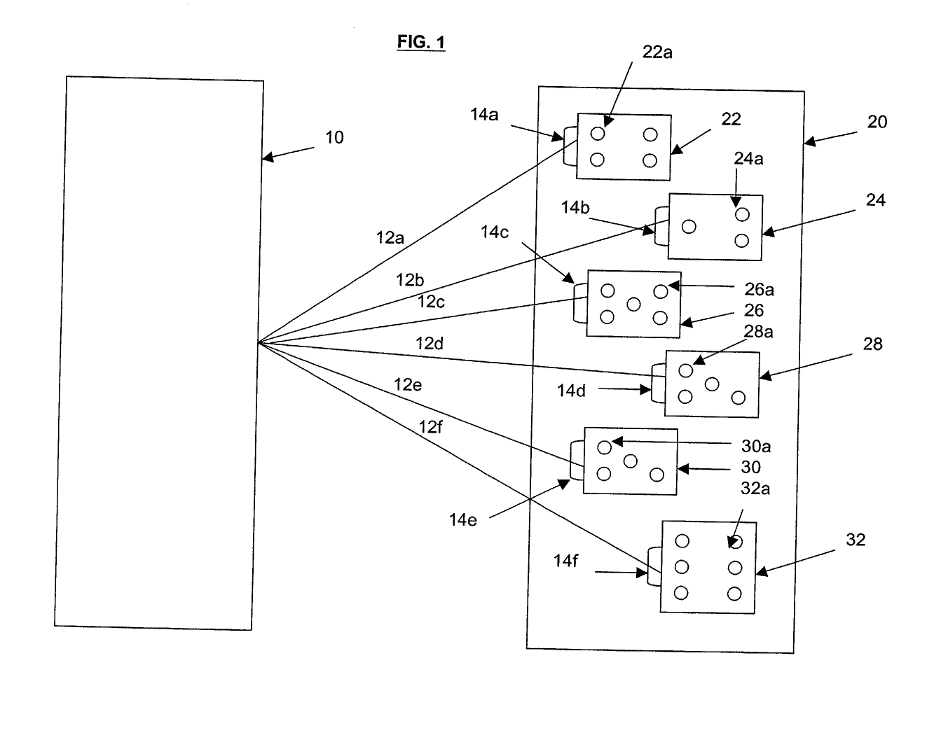

A communication system as is known, is depicted diagrammatically in FIG. 1, wherein CSP 10 is illustrated as providing communication service from a plurality of sources to a typical multiple occupant facility 20. Multiple occupant facility 20 is, for example, an office building including a plurality of individual office suites, designated as 22-32. Office suites 22-32 are of different size and require a different number of telephone extensions. Thus office suite 22 contains four telephone extensions 22a etc., office suite 32 contains six telephone extensions 32a, etc. Each office suites 22-32 includes individual PBX units 14a-14f for providing connection with each of telephone extensions 22a-32a. Each of the individual PBX units 14a-14f in office suites 22-32 is connected to CSP 10 through respective cables 12a-12f that include appropriate switches and connections. Other means of receiving communications from a CSP include, for example, a satellite signal-receiving disc.

PBX units 14a-14f are operative to route incoming and outgoing telephone communications to each of respective communication devices 22a -32a as examples of the plural telephone extensions in each office suite. PBX units 14a-14f do not have the capability of varying the particular service utilities for each of telephone extensions 22a-32a. Any such changes are implemented either at CSP 10 or through a specific telephone extension adapted to program instructions into the system.

Similarly, when communication service on one or more telephone devices 22a-32a is to be terminated or reduced, the user business contacts the CSP and instructs that the termination or revision be implemented. The CSP places the service request in a queue for attention in its sequential turn.

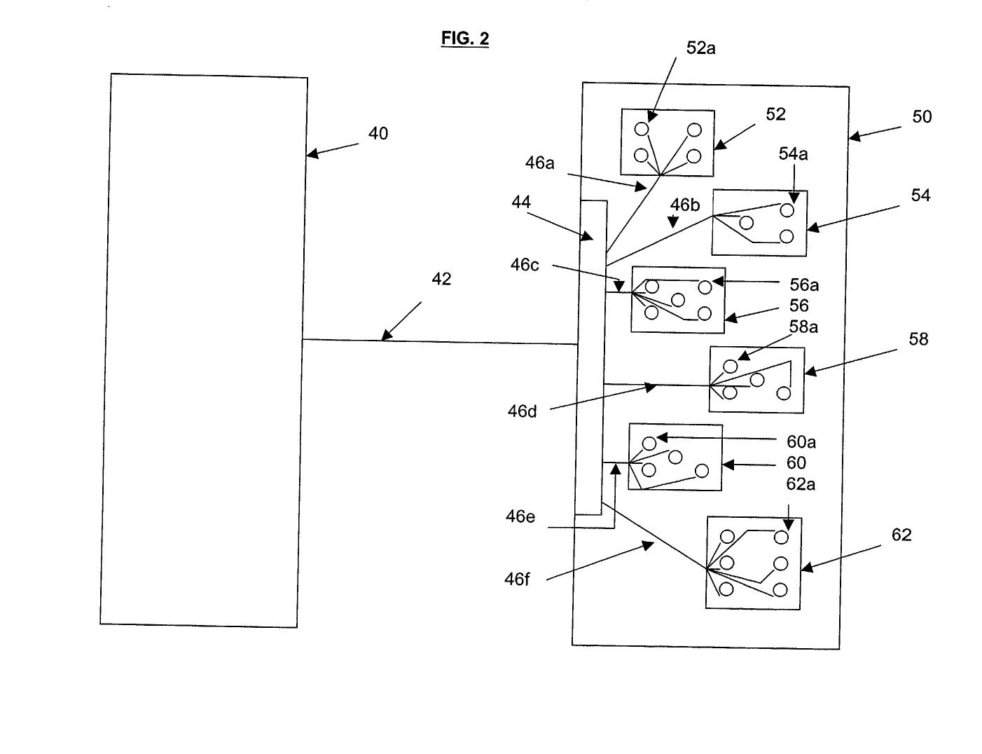

Referring now to FIG. 2, a CSP 40 is connected by a single cable or bus 42 to server 44 that is located within or adjacent to multiple occupant facility 50. Alternatively, connection 42 may be a wireless communication link, for example using a satellite dish. Server 44 is provided with programmed capability to provide particular communication service utilities, to control the function of individual telephone devices 52a-62a and to route incoming and outgoing communications. Telephone devices 52a and three others are connected within office suite 52, and so on. Depending on the number of possible individual telephone devices or other communication devices that may be used in facility 50, and depending on whether the external connection is electrical, optical, or other, a single or multiple cables 42 are required.

In essence, server 44 is configured to implement plural virtual private branch exchanges (“PBXs”), wherein the capability and capacity of each PBX may be configured by an administrator as described below. Within each virtual PBX, a sub-administrator may define functionality as if the virtual PBX were an actual PBX.

When multiple occupant facility 50, for example an office building, is constructed, each office suite 52-62 is provided with a maximum number of connection ports for communication devices 52a-62a. The number of connection ports utilized depends on the use to which the office suite is put, and in the figures, a varied number of communication devices 52a-62a appear in each office suite 52-62. A system administrator is appointed to operate computer 44 and administer communication services to each office suite 52-62.

When a business tenant occupies, for example office suite 52, four communication ports are activated and four communication devices 52a, etc., are connected. The required communication service utilities, for example voicemail, call waiting, call forwarding, etc., are requested of the system administrator. The requested services may be varied by each communication device 52a-62a throughout multiple occupant facility 50. Since the system administrator is a part of the building management and is directly responsible for communication services to the occupants of multiple occupant facility 50, the speed of implementing changes in communication service improves. In addition, individual business tenants are not required to purchase and maintain an individual PBX.

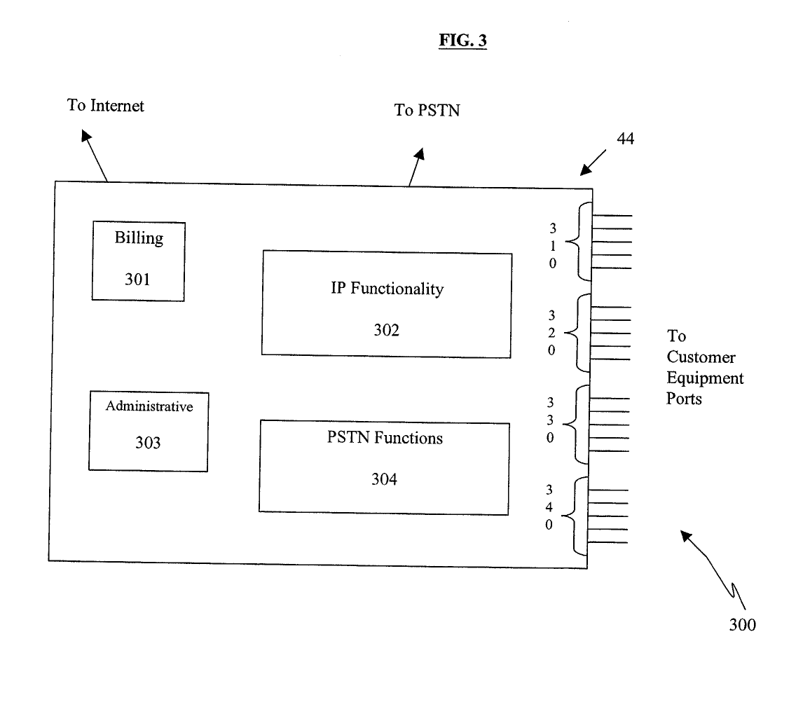

FIG. 3 shows a functional diagram of the server 44 comprising of a plurality of ports 300 connected to end user customer equipment. The server 44 includes four functional components, shown as billing 301, Internet Protocol (“IP”) functionality 302, administrative 303 and public switched telephone network (“PSTN”) functionality 304. The customer equipment ports 300 are divided into groups 310-340 as shown. The software within the administrative portion 303 treats these groups as separate PBXs, one being assigned to each particular office suite within an office building complex. The administrative function 303 determines which ports fall into which group.

In practice, an administrator may configure particular groups to include or exclude certain ports through a user interface (not shown). The administrator interfaces with the administrative software 303 in order to identify which particular ports fall into which particular groups 310-340. This technique facilitates offices changing their size or moving. For example, suppose initially group 330 corresponds to the extensions within one office suite, and group 340 corresponds to the extensions within the neighboring office suite in the building. All of the IP PSTN functionality is implemented separately for these groups of ports 330 and 340, so that it appears that each has its own PBX. Thus, calls may be transferred between extensions connected to group 330 without going through an outside line, but calls from extensions in group 330 are typically sent through an outside line if directed to an extension in group 340. Various parameters of each of the groups can be set through the administrative block 303.

Within each group of extensions, a sub-administrator may determine capabilities of each of the extensions within that group. Thus, the administrator within each group may set parameters such as outbound dialing lockout, or may turn off access to certain outside lines. The particular telephones affected by the sub-administrator will be changed if and when the administrator changes the set of extensions within the particular group at issue. Thus, if an office expands by absorbing space in an adjoining office, the group of extensions may change, and the extensions affected by the sub-administrator within that group will then be changed to add the new extensions.

Billing block 301 is programmed with a particular extension within each group. Billing block 301 then bills each group based upon a monthly fee which can be tied to square footage in the building, number of ports, or usage of those ports. A convenient manner in which to bill clients, albeit an unconventional one, may be based upon rental space within the building. In this manner, the cost of the equipment and maintenance may be amortized over the whole cost of the building similar to the way trash removal services, painting services, etc. are distributed by landlords to multiple tenants in a building based upon square footage.

IP functionality block 302 and PSTN function block 304 interface to the Internet and PSTN in a conventional fashion as shown. However, unlike conventional PBXs, each of the interfaces provided is separated by group based upon the customer equipment ports programmed to be within each group as outlined above.

In an additional embodiment, features are added to enhance flexibility that allow a user to render his extension portable. Consider for example an office suite that has ten extensions, wherein a user changes offices. The user may simply plug in his telephone to the port in the new office, and enter his password and the desired extension number. The new port will then assume the extension number that the user desires, which would likely be the extension number utilized by the individual in the previous office.

The administrator, through the administrative software 303, will set the information that determines which passwords are effective at which ports. This feature is useful because it may correspond to how the office suites are divided. More specifically, the administrator may program the system such that the passwords for each user are only effective to associate certain ports with an extension selected by the user. In this manner, a user may only assign himself an extension within his own office suite, and can not affect the extensions of others within the building which utilize the system.

While the present invention is described with respect to specific embodiments thereof, it is recognized that various modifications and variations thereof may be made without departing from the scope and spirit of the invention, which is more clearly understood by reference to the claims appended hereto.

What is claimed is:

1. A distributive system for establishing and controlling communication service to individual users in a multiple occupant facility, comprising:
(a) a computer
(b) a connection from a communication service provider to the computer so as to provide external communication from a plurality of sources;
(c) a plurality of communication devices connected to the computer; and
(d) whereas the computer is programmed to be able to provide selected communication service utilities to individual ones of the connected communication devices, and wherein communications devices are arranged in groups such that administrative functions performed by an administrator affect only communications devices within the group.

2. The distributive communication system as described in claim 1, wherein the communication devices are individual telephone extensions.

3. The distributive communication system as described in claim 1, wherein the communication devices exist in occupant groups that occupy separate facilities within the multiple occupant facility.

4. A method for establishing and controlling communication services to individual communication devices, comprising the steps of:
(a) connecting a communication service provider to a computer;
(b) connecting a plurality of communication devices to the computer; and
(c) establishing through programming in the computer selected communication utilities to each of the plurality of communication devices.

5. The method for establishing and controlling communication services to individual communication devices as described in claim 4, further comprising modifying communication services to the individual communication devices.

6. The method for establishing and controlling communication services to individual communication devices as described in claim 4, further comprising the step of requiring a password to access the computer for establishing and modifying the communication services.

7. The method for providing communication services to individual communication devices as described in claim 4, further comprising the step of deactivating selected communication services from selected of the communication devices for which the selected communication services had been established.

8. Apparatus for implementing plural virtual PBXs, the apparatus comprising administrative software for dividing plural customer equipment ports into groups, thereby determining which of such customer equipment ports are in each of said groups, and
a subadministrator within each group, the subadministrator being capable of affecting telecommunications parameters of all equipment connected to ports within the group, the particular equipment having parameters that the subadmisnistrator is able to affect being controlled by the administrative software.

8. The apparatus of claim 8 wherein the telecommunications parameters includes a parameter that determines whether calls between equipment may be made through an outside communications company or internal to said apparatus.

9. The apparatus of claim 8 further comprising software which bills users of said apparatus based at least in part upon square footage leased within a building.

10. The apparatus of claim 8 further comprising software which bills users of said equipment based at least in part on a number of customer equipment ports associated with said apparatus.

11. A PBX system having plural ports into which customer audio communications equipment may be plugged, the system having a means for accepting a password input at any such port from a customer communications equipment plugged into said port, means for verifying said password, means for accepting an extension number after verifying said password, the extension number then being assigned to correspond to said port.

12. The PBX system of claim 12 wherein a the password is only effective to permit a subset of the ports to be associated with the entered extension, the subset corresponding to all ports associated with a particular tenant in a building.

13. The PBX of claim 13 wherein said PBX stores information indicative of which passwords may be utilized with which ports to associate an extension with that particular port.

14. The PBX of claim 14 wherein said information in said PBX is alterable by an administrator via use of a password.
